(19) United States
(12) Patent Application Publication
(10) Pub. No.: US 2013/0329638 A1
(43) Pub. Date: Dec. 12, 2013

(54) AVOIDING PREMATURE E-UTRAN DISABLING

(71) Applicant: Qualcomm Incorporated, San Diego, CA (US)

(72) Inventors: Zhong Ren, San Diego, CA (US); Shyamal Ramachandran, San Diego, CA (US); Vitaly Drapkin, San Diego, CA (US)

(21) Appl. No.: 13/915,558

(22) Filed: Jun. 11, 2013

Related U.S. Application Data
(60) Provisional application No. 61/658,840, filed on Jun. 12, 2012.

(51) Int. Cl. H04W 60/00

(52) U.S. Cl. CPC H04W 60/005
USPC 370/328

(57) ABSTRACT

Methods, systems, and apparatuses for mobility management in wireless communications systems that provide both voice connection services and data services are disclosed. In some aspects, enhanced connectivity with wireless networks after a failure of voice connection services is provided. A counter may be utilized in connection with a combined registration procedure in which a device requests registration for both data services and voice connection services in the wireless network. The counter may track failed attempts to register for voice connection services when the request is accepted for data services. The counter may be reset in response to a deregistration event, such as a user input or a network command, allowing a full number of attempts for later registration with the wireless network.

### CROSS-REFERENCE TO RELATED APPLICATION

The present application for patent claims priority to the Provisional Application No. 61/658,840, filed Jun. 12, 2012, entitled “AVOIDING PREMATURE E-UTRAN DISABLING”, which is assigned to the assignee hereof and hereby expressly incorporated in its entirety by reference herein.

### BACKGROUND

1. Field

The following relates generally to wireless communication, and more specifically to disabling of wireless communications services based on wireless network conditions.

2. Background

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, 3GPP Long Term Evolution (LTE) systems, and orthogonal frequency-division multiple access (OFDMA) systems.

Generally, a wireless multiple-access communications system may include a number of base stations, each simultaneously supporting communication for multiple mobile devices. Base stations may communicate with mobile devices on downstream and upstream links. Each base station has a coverage range, which may be referred to as the coverage area, or tracking area, of the cell. In advanced wireless communications networks, multiple wireless communications technologies may be available within the same geographic areas. For example, a first wireless network having enhanced data communications rates may be available in a geographic area along with a second wireless network capable of supporting data communications at lower data rates than the first wireless network. One specific example may be an area having what is commonly referred to as “4G” coverage as well as “3G” coverage. An example of a 3G network may be a Universal Terrestrial Radio Assess Network (UTRAN), and an example of a 4G network may be an Evolved-Universal Terrestrial Radio Assess Network (E-UTRAN). User equipment that is capable of communicating on E-UTRAN may be capable of communication on UTRAN as well. Users having equipment with enhanced data rate capabilities may pay a premium for access to the enhanced data rate network. In this context, there remains a need for improved network connectivity to avoid premature disabling of the user equipment's connection to data services.

### SUMMARY

Methods, systems, and apparatuses for mobility management in wireless communications systems that provide both data services and voice connection services are provided. In some aspects, enhanced connectivity with wireless networks after a failure to register for voice connection services is provided. Repeated failures to register for voice connection services may result in the user equipment switching to a different wireless network, which may have reduced data services capabilities. As disclosed herein, a counter may be utilized in connection with a combined registration procedure by which a device requests registration for both data services and voice connection services in the wireless network. The counter may track failed attempts to register for voice connection services when the request is accepted for data services. The counter may be reset in response to a deregistration event, such as a user input or a network command, allowing a full number of attempts for later registration with the wireless network.

In some examples, there is provided a technique for improved wireless network connectivity in the context of a combined registration procedure (e.g., a combined attach procedure or a combined tracking area update (TAU) procedure) for packet switched (PS) services and circuit switched (CS) services. The technique may involve performing the combined registration procedure within a tracking area of a wireless network, including sending a request for the PS services and the CS services to the wireless network. The technique may further involve incrementing a combined procedure counter upon determining that the request is accepted for the PS services but not for the CS services. The technique may further involve incrementing the counter for each unsuccessful attempt to register for CS services in the tracking area. The technique may involve resetting the counter in response to entering a deregistered state.

In related aspects, the technique may involve: determining a count value of a combined procedure counter upon determining that the request is accepted for at least the PS services; and resetting the counter to zero in response to (a) the count value being non-zero and (b) the UE entering a deregistered state. In further aspects, an electronic device (e.g., a user equipment) or component(s) thereof may be configured to execute the above described techniques.

Other examples include a technique that may involve: detecting a transition to a deregistered state by a user equipment; and resetting a combined registration counter responsive to the transition. The technique may further involve performing a combined registration procedure comprising sending a request for PS services and CS services to the wireless network. The technique may further involve: incrementing the counter for each unsuccessful attempt to register for CS services subsequent to sending the request; and transitioning to the deregistered state when the counter reaches a predetermined value.

In some examples, a wireless connection may be established within a tracking area of a wireless network, the establishment of the wireless connection including requesting registration with the wireless network for both data and voice services. A count value may be updated when an attempt to register for the voice services fails. The count value may be reset to an initial value in response to entering a deregistered state, which may occur when the count value is different than a predetermined value and the user equipment remains within the tracking area. Deregistration may also occur, for example, based on a command from a user of the user equipment, based on a command from the wireless network, or substantially upon the user equipment leaving the tracking area.

In some examples, data services with a first wireless network are deregistered when the count value reaches an identified count value at which the data services are to be deregistered, and a wireless connection with a second wireless network is established. The second wireless network may have reduced data communication bandwidth compared to the first wireless network. In some examples, establishing a wireless connection may include performing a combined attach procedure to request registration with the first wireless network for both data and voice services, receiving a notice that only the request for data services is accepted by the first wireless network, and updating a count value by changing the count value from an initial value to a first value. Following the combined attach procedure, a combined tracking area updating procedure may be performed to request registration for the voice services with the first wireless network. A notice that the request for registration for the voice services with the first wireless network has failed may be received, and the count value may updated from the first value to a second value. The data services with the first wireless network may be deregistered when the second value equals a predetermined value, and a wireless connection with a second wireless network may be established. The first wireless network may include a E-UTRA network or the like.

In other examples, novel functionality for wireless communications includes establishing a wireless connection within a first tracking area of a first wireless network, the establishing including: registering with the first wireless network for data services, and attempting to establish voice connection services using the first wireless network. A count value may be updated when establishment of the voice connection services fails. A predetermined count value at which the attempting to establish voice connection services will be suspended is identified, in some examples. The count value may be reset to an initial value in response to a deregistration from the first wireless network when the count value is different than the predetermined value and the user equipment is within the first tracking area. In some examples, attempting to establish voice connection services is suspended, and may include providing a notice to a user of the user equipment that voice services are not available and/or prompting a user of the user equipment to deregister data services with the first wireless network if voice connection services are desired.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of a wireless communications system;

FIG. 2 is a block diagram of an exemplary wireless communications system having multiple communications networks that provide voice and data services;

FIGS. 3A and 3B show a diagram of a user equipment exiting and entering a coverage area of different types of wireless communications networks;

FIG. 4 is a block diagram of an exemplary a user equipment;

FIG. 5 is a block diagram of a wireless communications system that includes a base station and a user equipment;

FIG. 6 is a flowchart of a method for communications with a wireless communications network that provides voice and data services;

FIG. 7 is a flowchart of another method for communications with a wireless communications network that provides voice and data services;

FIG. 8 is a flowchart of a method for communications with a UE that exits a tracking area of a wireless communications network that provides voice and data services;

FIG. 9 is a flowchart of another method for communications with a wireless communications network that provides voice and data services;

FIG. 10 is a flowchart of another method for communications with a wireless communications network that provides voice and data services;

FIG. 11 is a flowchart of another method for communications with a wireless communications network that provides voice and data services;

FIG. 12 is a flowchart of yet another method for communications with a wireless communications network that provides voice and data services; and

FIG. 13 is a flowchart of still another method for communications with a wireless communications network that provides voice and data services.

### DETAILED DESCRIPTION

Methods, systems, and devices for mobility management in wireless communications systems that provide both data services and voice connection services are provided. Some embodiments provide enhanced connectivity with wireless networks after a failure of voice connection services. Repeated failures of voice connection services may result in the user equipment switching to a different wireless network, which may have reduced data services capabilities. A counter may be established when data services are established with a wireless network and an attempt to establish voice connection services through the wireless network fails. The counter may be reset in response to a deregistration from the wireless network, allowing a full number of attempts for later registration with the wireless network, rather than a reduced number of attempts had the count value been maintained on deregistration.

The following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

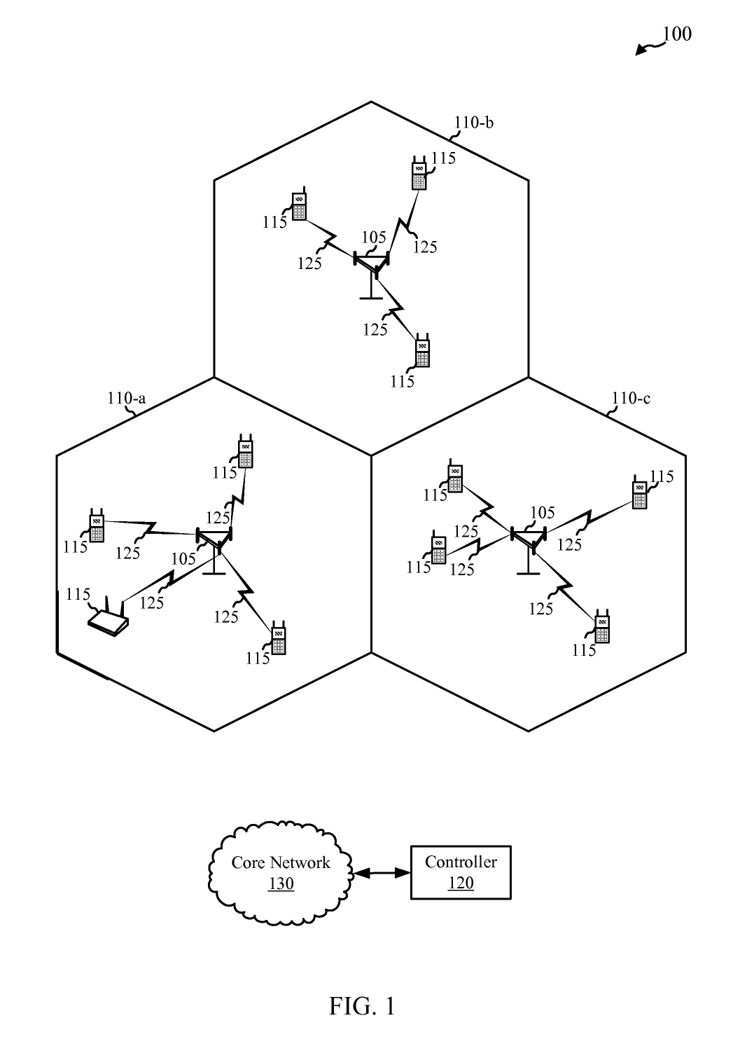

Referring first to FIG. 1, a block diagram illustrates an example of a wireless communications system 100 in accordance with various embodiments. The system 100 includes base stations 105, mobile devices 115, a base station controller 120, and a core network 130 (the controller 120 may be integrated into the core network 130 in some embodiments; in some embodiments, controller 120 may be integrated into base stations 105). The system 100 may support operation on multiple different wireless communications networks. For example, the system may provide GSM EDGE Radio Access Network (GERAN), UTRAN and E-UTRAN capability for mobile devices 115. Each wireless communications network can transmit modulated signals according to the protocols of the particular network. System 100, for example, shows transmissions 125 between mobile devices 115 and base stations 105. The transmissions 125 may include uplink and/or reverse link transmission, from a mobile device 115 to a base station 105, and/or downlink and/or forward link transmissions, from a base station 105 to a mobile device 115. Each modulated signal may be a Code Division Multiple Access (CDMA) signal, Time Division Multiple Access (TDMA) signal, Frequency Division Multiple Access (FDMA) signal, Orthogonal FDMA (OFDMA) signal, Single-Carrier FDMA (SC-FDMA) signal, etc. Each modulated signal may be sent on a different carrier and may carry control information (e.g., pilot signals), overhead information, data, etc.

The mobile devices 115 may be any type of mobile station, mobile device, access terminal, subscriber unit, or user equipment, and are generally referred to herein as mobile devices or user equipment. The mobile devices or user equipment 115 may include cellular phones and wireless communications devices, but may also include personal digital assistants (PDAs), smartphones, other handheld devices, netbooks, notebook computers, tablet computers, etc. Thus, the term mobile device should be interpreted broadly hereinafter, including the claims, to include any type of wireless or mobile communications device. According to various embodiments, mobile devices 115 may be capable of communication using one or more wireless communications networks available in system 100.

In situations where one or more of the wireless communications networks available using system 100 provide enhanced communications capabilities, users having mobile devices 115 capable of communications on such networks may desire that such enhanced communications capabilities be available on their mobile devices 115. For example, if system 100 supports GERAN, UTRAN, and E-UTRAN, users of mobile devices 115 that are capable of operating in E-UTRAN may desire that E-UTRAN services be available if they are within an E-UTRAN service area. Additionally, users may pay a premium for access to E-UTRAN services, thus further increasing the desire that E-UTRAN services be available when the users are within an E-UTRAN service area. Thus, although such mobile devices 115 may be capable of communications using GERAN or UTRAN, use of these networks may be less favorable.

The base stations 105 may wirelessly communicate with the mobile devices 115 via one or more base station antennas. The base stations 105 may be configured to communicate with the mobile devices 115 under the control of the controller 120 via multiple carriers. Each of the base station 105 sites can provide communication coverage for a respective geographic area 110. In some embodiments, base stations 105 may be referred to as a NodeB, evolved NodeB (eNodeB), Home NodeB, and/or Home eNodeB. The coverage area for each base station 105 here is identified as 110-a, 110-b, or 110-c. As will be readily understood, in systems 100 that provide capability of communications using multiple different networks, each base station 105 may include capabilities for connection to one or more of the available networks. Continuing with the above example, system 100 may provide GERAN, UTRAN, and E-UTRAN services, with some base stations 105 providing only E-UTRAN services and other base stations 105 providing GERAN, UTRAN, and E-UTRAN services. Furthermore, the coverage areas 110 base stations 105 may overlap. Mobile devices 115 may move between coverage areas 110-a, 110-b, and 110-c, with continuity of communications maintained between base stations 105 and mobile devices 115. Continuity of communications is maintained through procedures such as tracking area updates or routing area updates with base stations 105. A tracking area is a set of base station coverage areas, and may be grouped into lists of tracking areas (TA lists), which can be configured on mobile devices 115. Tracking area updates may be performed periodically or when a mobile device 115 moves to a tracking area that is not included in its TA list.

In some cases, one or more of the wireless networks available in system 100 may provide different services than other of the available networks. Mobile devices 115 in such situations may connect to different wireless networks depending upon the services required. For example, system 100 may provide GERAN, UTRAN, and E-UTRAN services, in which E-UTRAN provides evolved packet system (EPS) services or packet switched (PS) services but does not provide circuit switched (CS) services that may be required for mobile devices 115 to support voice calls. In such cases, E-UTRAN may be used by a mobile device 115 for data services, with GERAN or UTRAN used in situations requiring CS services. In some situations, a mobile device 115 may perform a combined registration procedure to register with an enhanced data services network, such as E-UTRAN, for data services and for other required services such as CS services through UTRAN or GERAN. In situations where there is a failure of the registration for one or more of the required services, the mobile device 115 may be required to deregister from the enhanced data services network and connect to another network, with attempts to re-establish a connection with the enhanced data services network restricted based on time or some other criteria. In such cases, a mobile device 115 may not be able to access available enhanced data services for a period of time.

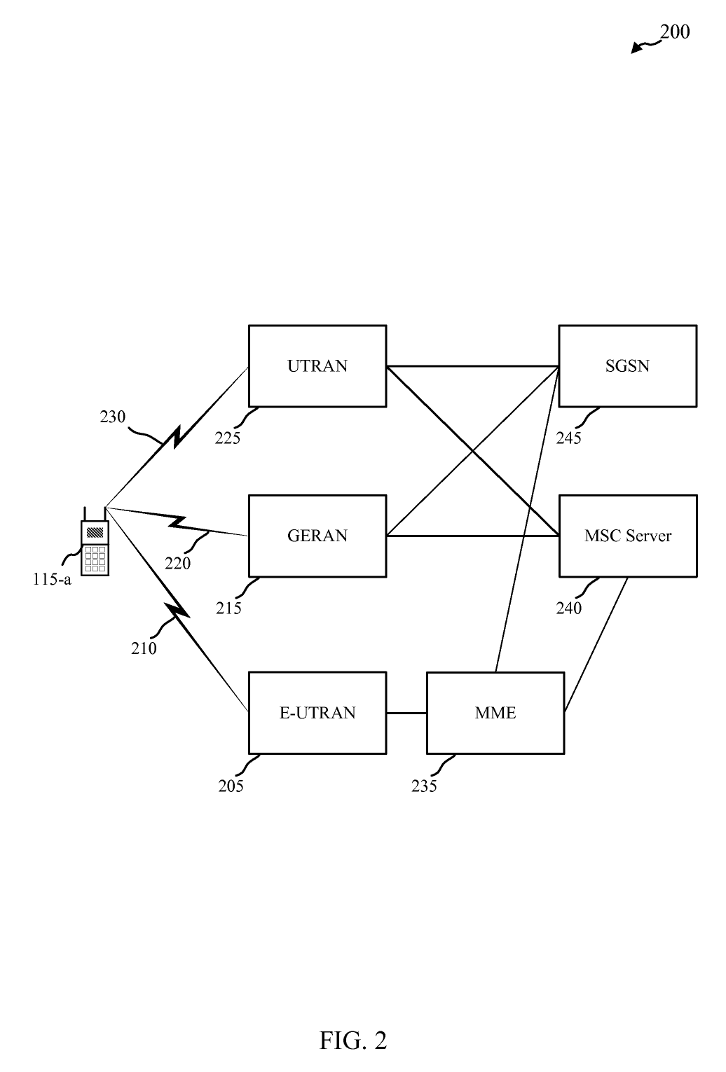

With reference now to FIG. 2, a block diagram illustrates an example of a wireless communications system 200 in accordance with various embodiments in which a user equipment 115-a may connect to different networks based on services required at the user equipment 115. In this example, user equipment 115-a may use E-UTRAN 205 services via transmissions 210, may use GERAN 215 services via transmissions 220, and may use UTRAN 225 services via transmissions 230. A Mobility Management Entity (MME) 235 may serve as a control-node for the E-UTRA network 205. MME 235 may control, for example, idle mode user equipment tracking and paging procedures, bearer activation/deactivation processes, user authentication, authorization of the user equipment to camp on the service provider's network, enforcement of user equipment roaming restrictions, and network for ciphering/integrity protection. The MME 235 may also provide a control plane function for mobility between E-UTRAN and UTRAN 225 or GERAN 215. In the illustration of FIG. 2, MME 235 is connected with mobile switching center (MSC) server 240, and Serving GPRS Support Node (SGSN) 245. MSC server 240 may provide the primary service delivery node for GERAN 215 or UTRAN 225 and may provide CS services for routing voice calls and SMS as well as other services. SGSN 245 may provide packet switched data services for GERAN 215 or UTRAN 225.

As mentioned above, in some situations, user equipment 115-a may require CS services that are not available through E-UTRAN 205. The user equipment 115-a, in such situations, may register for services through E-UTRAN 205, and receive EPS/PS services through E-UTRAN 205. However, CS services may not be available through E-UTRAN 205 directly. Such CS services may include, for example, voice and its supplementary services (e.g. call waiting, call forwarding), USSD, LCS, SMS, E911, LI, etc. In some cases, such features may be available through IP Multimedia System (IPS). However, user equipment 115-a and/or E-UTRAN 205 may not include IMS capability. CS services may be provided in such situations through a procedure referred to as CS Fallback (CSFB). CSFB may allow a user equipment 115-a connected with E-UTRAN 205 to switch to GERAN 215 or UTRAN 225 when CS services are required. Utilizing CSFB, a user equipment 115-a may access relatively high bandwidth EPS services through E-UTRAN 205 and may switch over to GERAN 215 or UTRAN 225, for example, to access CS domain services when needed.

In situations where CSFB is needed for CS services, a user equipment 115-a registers itself to the CS domain via EPS through E-UTRAN 205. User equipment 115-a may perform a combined attach procedure to register E-UTRAN 205 EPS and CSFB services. Following initial registration with E-UTRAN 205, user equipment 115-a may perform periodic combined Tracking Area Update (TAU) procedures with E-UTRAN 205. Following a combined attach procedure, or a combined TAU procedure, E-UTRAN 205 may indicate back to the user equipment 115-a whether the combined procedure is accepted and the services that the combined procedure is accepted for. For example, a user equipment 115-a may perform a combined attach request with E-UTRAN 205, and receive a notice that the request is accepted for PS services only. In such a case, user equipment 115-a is registered with E-UTRAN 205 for data services. User equipment 115-a may then again attempt to register for CS services through a combined TAU procedure. In some embodiments, user equipment 115-a may deregister with E-UTRAN 205 and attempt registration with GERAN 215 or UTRAN 225 following a predetermined number of failed attempts for CS services registration.

In situations where both EPS and CS services are successfully registered through E-UTRAN 205, user equipment 115-a may request the MME 235 to perform CSFB procedures when CS domain services are required (e.g. originating a voice call or answer to a terminating voice call). In some embodiments, a voice call to be terminated at user equipment 115-a arrives at MSC server 240, which then signals the incoming call to MME 235. The user equipment 115-a may be paged through E-UTRAN 205 if in idle mode, or notified of the call if in active mode. In situations in which a voice call is terminating at user equipment 115-a, the user equipment 115-a may, in some examples, reject terminating call request while it still resides in EPS, which may be desired when a user of user equipment 115-a is engaged in an activity requiring EPS services (e.g., streaming video to mobile device 115-a).

As indicated above, it is often desirable for a user equipment 115-a to receive PS services through E-UTRAN 205 when such services are available. Such E-UTRAN 205 services may be desirable due to higher bandwidth data transfers through E-UTRAN 205. Furthermore, a user of user equipment 115-a may pay a service provider a premium for the capability of utilizing E-UTRAN 205 services, and therefore such services are expected to be provided if available. However, as mentioned above, in situations where a user equipment 115-a has repeated failures of CS services registrations, the user equipment 115-a may be required to deregister with E-UTRAN 205 and register with UTRAN 225 or GERAN 215 in order to provide capabilities for CS services. In some cases, a counter may be incremented following a failure to establish CS services (also referred to generally as voice connection services), and E-UTRAN services are deregistered when the counter reaches a predetermined value. In some examples, a user equipment 115-a deregisters from E-UTRAN following five failed attempts to register voice services.

In some instances, however, E-UTRAN 205 services may be deregistered following failed voice connection services requests before the counter reaches the predetermined value. In such cases, the counter at user equipment 115-a may be reset to an initial value even though voice services were not successfully registered. For example, E-UTRAN 205 may initiate a detach command with instructions to perform a reattach procedure towards user equipment 115-a, resulting in the user equipment 115-a deregistering from E-UTRAN 205. When user equipment 115-a performs a combined attach procedure with E-UTRAN 205, voice services may again fail to be established. If the counter at user equipment 115-a is not reset, the mobile device may have a reduced number of voice services registration requests available, which may result in E-UTRAN 205 services being disabled for user equipment 115-a, when a further attempt to establish voice services may have been successful. For example, user equipment 115-a may perform a combined attach procedure, which is accepted for PS services only. The user equipment 115-a, as a result of the failure to establish voice connection services, may increment the counter to one. The user equipment 115-a may then perform a combined TAU procedure to register for voice connection services, which fails to establish voice connection services. The user equipment 115-a may increment the counter to two as a result of the failure to establish voice connection services with the combined TAU procedure. This may be repeated until the counter at the user equipment 115-a is four, for example. At this point, user equipment 115-a may deregister from E-UTRAN 205 for reasons unrelated to the failed voice services connection requests. If the counter is not reset, the user equipment 115-a, may perform a combined attach procedure, which is successful for EPS services only, resulting in the user equipment 115-a deregistering from E-UTRAN 205. In such a case, the user equipment 115-a may prematurely disable E-UTRAN connectivity and be restricted from performing a combined attach procedure for some amount of time. According to the present disclosure, user equipment 115-a may reset the counter when entering a deregistered state even when the counter is not at the predetermined value and the user equipment 115-a is within the same tracking area of E-UTRAN 205 as when EPS services were registered. Transitioning into the deregistered state may occur for a number of reasons. For example, the user equipment 115-a may be deregistered at the request of the user, at the request of the network, and/or substantially upon leaving a tracking area of E-UTRAN 205, for example.

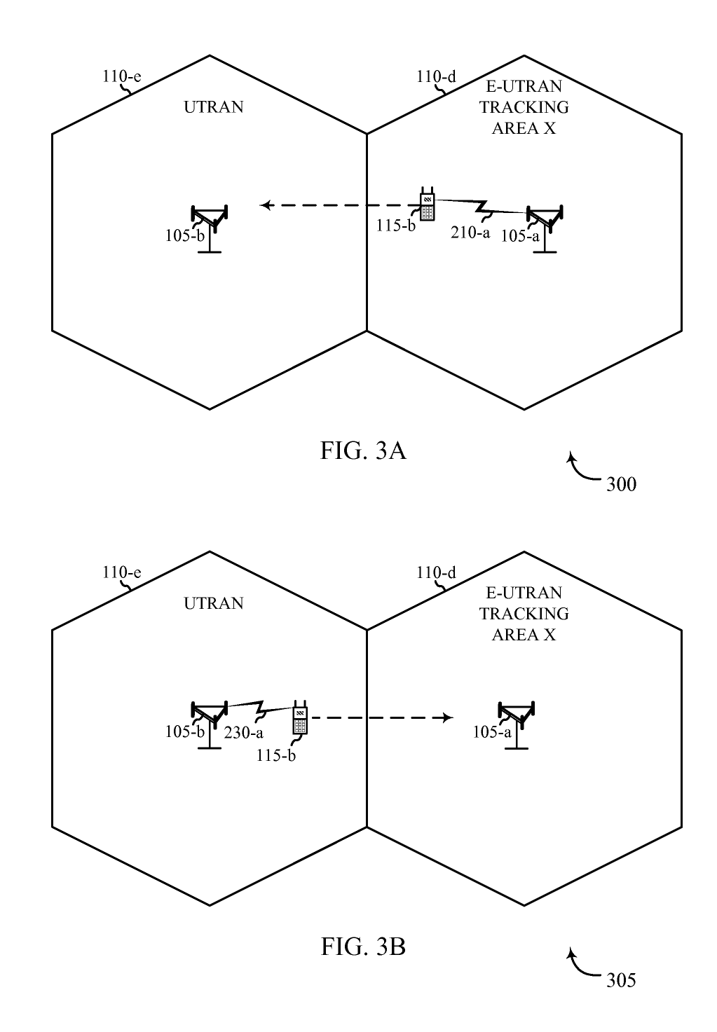

In another example, illustrated in FIGS. 3A and 3B, deregistration from E-UTRAN may occur based on location of a user equipment 115-b, illustrated in system 300 of FIG. 3A. In this example, user equipment 115-b may be registered with E-UTRAN tracking area 110-d, communicating with E-UTRAN through base station 105-a and transmissions 210-a. User equipment 115-b, in this example, may move out of E-UTRAN tracking area 110-d, and into a UTRAN routing area 110-e that is served through base station 105-b. In such a case, E-UTRAN deregistration occurs substantially upon user equipment 115-b leaving E-UTRAN tracking area 110-d. A counter of failed voice connection services attempts is also reset substantially upon deregistration of E-UTRAN services. For example, if a combined attach request, and/or combined TAU procedure, has resulted in a failure of voice connection services through E-UTRAN tracking area 110-d, the counter at user equipment 115-b may be incremented. System 305 of FIG. 3B illustrates user equipment 115-b re-entering E-UTRAN tracking area 110-d. When user equipment 115-b re-enters E-UTRAN tracking area 110-d, a combined attach procedure may be initiated to register with E-UTRAN services. In the event of a failure of voice connection services the counter may be incremented at user equipment 115-b. By resetting the counter upon deregistration of E-UTRAN services or transitioning to the deregistered state, the user equipment 115-b will then be allowed the full number of voice services registration attempts prior to disabling of E-UTRAN services at the user equipment 115-b. Such a situation may occur, for example, when a user of user equipment 115-b travels from a workplace to home. In such an example, the user's workplace may be located in E-UTRAN tracking area 110-d and the user's home may be located outside of an E-UTRAN tracking area 110-d and within UTRAN routing area 110-e. When the user travels from their workplace to their home, they no longer have E-UTRAN service available, and when they travel back to their workplace they enter the same E-UTRAN tracking area 110-d that previously provided E-UTRAN services. Upon re-entry into E-UTRAN tracking area 110-d, user equipment 115-b may initiate a combined attach procedure and attempt to register EPS/PS and CS services, similarly as described above. Of course, the deregistration examples provided above provide but a few examples of situations in which E-UTRAN services may be deregistered when a count value at the user equipment 115-b is different than a predetermined value.

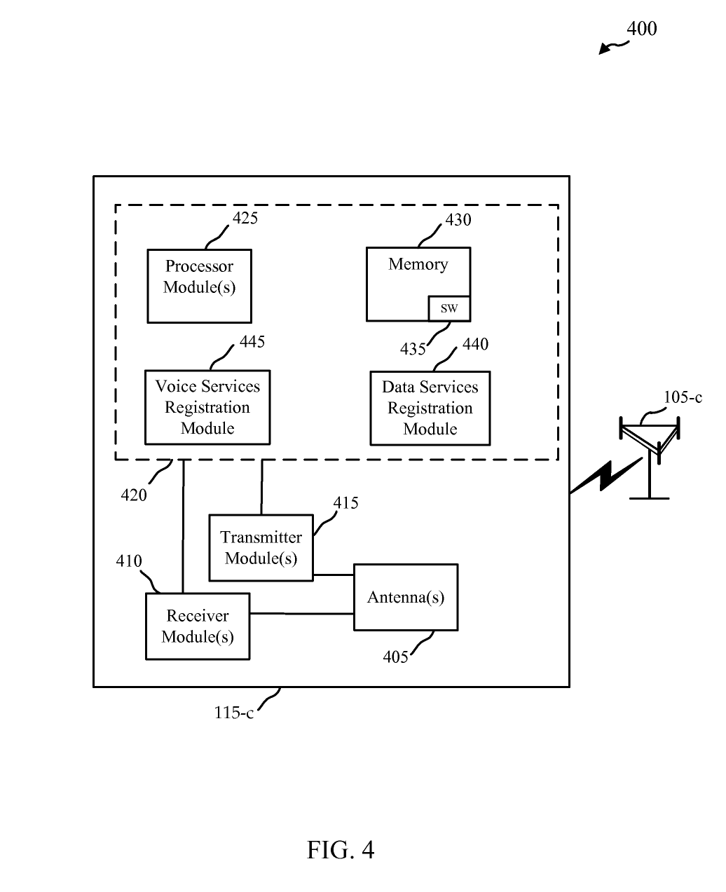

With reference now to FIG. 4, an example wireless communication system 400 that resets a failed voice connection services counter upon deregistration is depicted. System 400 includes a user equipment 115-c that may communicate with base station 105-c to receive access to one or more wireless networks as described above. User equipment 115-c may be an example of a user equipment 115 of FIGS. 1-3. User equipment 115-c includes one or more antenna(s) 405 communicatively coupled to receiver module(s) 410 and transmitter module(s) 415, which are in turn communicatively coupled to a control module 420. Control module 420 includes one or more processor module(s) 425, a memory 430 that contains software 435 for execution by processor module 425, a data services registration module 440, and a voice services registration module 445.

The processor module 425 may include an intelligent hardware device, e.g., a central processing unit (CPU), such as those made by QUALCOMM® Incorporated microcontroller, an application specific integrated circuit (ASIC), etc. The memory 430 may include random access memory (RAM) and read-only memory (ROM). The memory 430 may store computer-readable, computer-executable software code 435 containing instructions that are configured to, when executed (or when compiled and executed), cause the processor module 425 to perform various functions described herein (e.g., registration of data and/or voice services, deregistration of data and/or voice services, counter incrementing and resetting, etc.).

The transmitter module(s) 415 may transmit to base station 105-c (and/or other base stations) to establish communications with one or more wireless communications networks (e.g., E-UTRAN, UTRAN, etc.), as described above. The receiver module(s) 420 may receive downlink transmissions from base station 105-c (and/or other base stations), as described above. Downlink transmissions are received and processed at the user equipment 115-c. Data services registration module 440 may perform attach, or combined attach procedures, as well as TAU procedures, as described herein, to register data services with one or more wireless communication networks. Voice services registration module 445 may perform attach, or combined attach procedures, as well as TAU procedures, as described herein, to register voice connection services with one or more wireless communication networks. It is noted that a single data/voice module may configured to perform combined attach procedures for both data and voice services.

Voice services registration module 445, in this embodiment, includes a counter 450 that may be used to track unsuccessful attempts to register voice connection services with the one or more wireless communications networks. As discussed above, in the event that establishment of voice connection services with a wireless communication network fails, the counter 450 may be incremented, and data services with the wireless communication network deregistered in the event that the counter 450 reaches a predetermined number. Counter 450 may be reset in the event of a deregistration from the wireless communication network, thus providing user equipment 115-c a full number of attempts at voice services registration when the user equipment 115-c again attempts to connect with the wireless communications network. The components of the user equipment 115-c may, individually or collectively, be implemented with one or more Application Specific Integrated Circuits (ASICs) adapted to perform some or all of the applicable functions in hardware. Each of the noted modules may be a means for performing one or more functions related to operation of the user equipment 115-c.

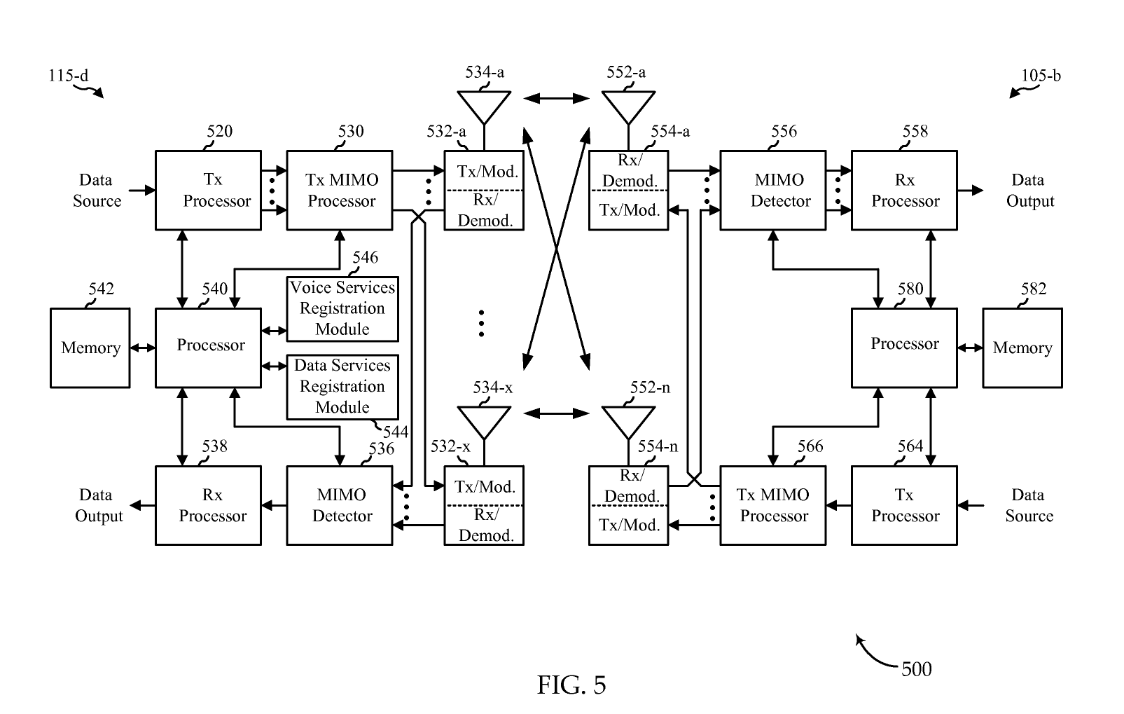

Referring now to FIG. 5, a block diagram of a system 500 including a base station 105-d and a user equipment 115-d is described. This system 500 may be a portion of the systems 100, 200, 300 and/or 400 of FIGS. 1-4, respectively. The base station 105-d may be equipped with antennas 532-a through 532-x, and the user equipment 115-d may be equipped with antennas 532-a through 532-n. User equipment 115-d and base station 105-d may communicate according to network protocols of one or more wireless communications networks, such as, for example, E-UTRAN, UTRAN, and GERAN, similarly as discussed above. At the user equipment 115-d, a transmit processor 520 may receive data from a data source and from a processor 540, data services registration module 544, and/or voice services registration module 546. Data services registration module 544 may perform, or assist in the performance, of attach procedures, combined attach procedures, TAU procedures, and/or combined TAU procedures. Voice services registration module 546 also may perform, or assist in the performance, of attach procedures, combined attach procedures, TAU procedures, and/or combined TAU procedures.

In one aspect, user equipment 115-d may attempt to register data services and voice connection services with respect to the wireless communication network(s). In the event that registration of data services is successful and registration of voice connection services is not successful, voice services registration module 546 may update a counter. In the event that the counter reaches a predetermined value, attempts to establish voice connection services may be suspended. In some cases, suspension of attempts to establish voice connection services includes deregistering data services with the wireless network (e.g., transitioning to a deregistered state in E-UTRAN) and attempting to register voice and data services on another wireless communications network (e.g., initiating a UTRAN or GERAN connection). In other cases, suspension of attempts to establish voice connection services includes discontinuing attempts to establish voice connection services while maintaining data services registration with the wireless communications network. User equipment 115-d may provide a notification to a user that voice services are not currently available and optionally provide for user input regarding deregistering data services with the wireless network in favor of attempting to establish voice and data services on a different network.

Transmit processor 520 may receive control information from processor 540, data services registration module 544, and/or voice services registration module 546. The control information may include information related to registration attempts, deregistration, attach procedure attempts, and TAU procedures to be performed for a particular user equipment 115-d. The transmit (TX) processor 520 may process (e.g., encode and symbol map) the data, and control information to obtain data symbols and control symbols, respectively. The transmit processor 520 may also generate reference symbols, and cell-specific reference signal. A transmit multiple-input multiple-output (MIMO) processor 530 may perform spatial processing (e.g., precoding) on the data symbols, the control symbols, and/or the reference symbols, if applicable, and may provide output symbol streams to the transmit modulators 532-a through 532-x. Each modulator 532 may process a respective output symbol stream (e.g., for OFDM, etc.) to obtain an output sample stream. Each modulator 532 may further process (e.g., convert to analog, amplify, filter, and upconvert) the output sample stream to obtain a uplink signal. Uplink signals from modulators 532-a through 532-x may be transmitted via the antennas 532-a through 532-x, respectively.

At the base station 105-d, the antennas 552-a through 552-n may receive the uplink signals from the user equipment 115-d and may provide the received signals to the demodulators 554-a through 554-n, respectively. Each demodulator 554 may condition (e.g., filter, amplify, downconvert, and digitize) a respective received signal to obtain input samples. Each demodulator 554 may further process the input samples (e.g., for OFDM, etc.) to obtain received symbols. A MIMO detector 556 may obtain received symbols from all the demodulators 554-a through 554-n, perform MIMO detection on the received symbols if applicable, and provide detected symbols. A receive processor 558 may process (e.g., demodulate, deinterleave, and decode) the detected symbols, providing decoded data to a data output, and provide decoded control information to a processor 580, or memory 582. Receive processor 558 also may perform error correction on the decoded data to correct bit errors that may be present in the decoded data.

On the uplink, at the base station 105-d, a transmit processor 564 may receive and process data from a data source and from the processor 580 and memory 582. The transmit processor 564 may also generate reference symbols for a reference signal. The symbols from the transmit processor 564 may be precoded by a TX MIMO processor 566 if applicable, further processed by the demodulators 554-a through 554-n (e.g., for SC-FDMA, etc.), and be transmitted to the user equipment 115-d. At the user equipment 115-d, the downlink signals from the base station 105-d may be received by the antennas 534, processed by the demodulators 532, detected by a MIMO detector 536 if applicable, and further processed by a receive (RX) processor 538 to obtain decoded data and control information sent by the base station 105-c. The receive processor 538 may provide the decoded data to a data output and decoded control information to the processor 540. The components of the user equipment 115-d may, individually or collectively, be implemented with one or more Application Specific Integrated Circuits (ASICs) adapted to perform some or all of the applicable functions in hardware. Each of the noted modules may be a means for performing one or more functions related to operation of the system 500. Similarly, the components of the base station 105-d may, individually or collectively, be implemented with one or more Application Specific Integrated Circuits (ASICs) adapted to perform some or all of the applicable functions in hardware. Each of the noted modules may be a means for performing one or more functions related to operation of the system 500.

For example, the data services registration module 544 and the voice services registration module 546 of the user equipment 115-d may be configured to perform a combined registration procedure (e.g., a combined attach procedure, a TAU procedure, or the like) within a tracking area of a wireless network. The combined registration procedure may include having the data services registration module 544, voice services registration module 546, and/or the processor 540 instruct the TX processor, the TX MIMO processor, and/or ones of the transmit modulators 532-a through 532-x to send a request for PS services and CS services to the wireless network (e.g., via the base station 105-d or the like).

The voice services registration module 546 and/or the processor 540 may be configured to increment a combined procedure counter upon determining that the request is accepted for the PS services but not for the CS services. Determining that the request is accepted for the PS services but not for the CS services may involve the receive demodulators 532-a through 532-x, the MIMO detector 536, and/or the RX processor 538 receiving an accept message from the network indicating acceptance for the PS services but not for the CS services.

The voice services registration module 546 and/or the processor 540 may be configured to increment the counter for each unsuccessful attempt to register for CS services in the tracking area. The voice services registration module 546 and/or the processor 540 may be configured to reset the counter in response to entering a deregistered state. The memory 542 of the user equipment 115-d may include instructions or other data for performing the combined registration procedure and counter adjustment techniques described herein.

Entering the deregistered state may involve: the data services registration module 544 and/or the processor 540 receiving a deregistration command from a user of the UE, and deregistering the PS services or detaching from the network.

Entering the deregistered state may involve: (a) the receive demodulators 532-a through 532-x, the MIMO detector 536, and/or the RX processor 538 receiving a command from the network to detach from the network; and (b) the data services registration module 544 and/or the processor 540 deregistering the PS services with the network in response to receiving the command, and resetting the counter to an initial value upon deregistering the PS services.

Entering the deregistered state may involve: (a) the data services registration module 544 and/or the processor 540 deregistering the PS services with the network when the counter reaches a predetermined value; and (b) the data services registration module 544, the voice services registration module 546, and/or the processor 540 establishing a wireless connection with another wireless network (e.g., via the base station 105-d or the like).

In another example, the receive demodulators 532-a through 532-x, the MIMO detector 536, and/or the RX processor 538 may receive a notice that registration for the CS services (in) (with?) the network has failed. The voice services registration module 546 and/or the processor 540 may be configured to change the counter from a first value to a second value. In one approach, when the second value equals a predetermined value, the data services registration module 544 and the voice services registration module 546 may be configured to deregister from the network and establish a wireless connection with another wireless network. In another approach, the receive demodulators 532-a through 532-x, the MIMO detector 536, and/or the RX processor 538 may receive receiving a command to deregister with the network, when the second value is different than a predetermined value, thereby triggering the data services registration module 544, the voice services registration module 546, and/or the processor 540 to reset the counter to an initial value upon deregistering the PS services.

In yet another example, the data services registration module 544, the voice services registration module 546, and/or the processor 540 may be configured to determine a count value of a combined procedure counter upon determining that the request is accepted for at least the PS services. The data services registration module 544, the voice services registration module 546, and/or the processor 540 may be configured to reset the counter to zero in response to (a) the count value being non-zero and (b) the user equipment 115-d entering a deregistered state.

In still another example, the data services registration module 544, the voice services registration module 546, and/or the processor 540 may be configured to: (a) detect a transition to a deregistered state by the user equipment 115-d; (b) reset a combined registration counter responsive to the transition; (c) perform a combined registration procedure comprising sending a request for PS services and CS services to the wireless network; (d) incrementing the counter for each unsuccessful attempt to register for CS services subsequent to sending the request; and (e) transitioning to the deregistered state when the counter reaches a predetermined value.

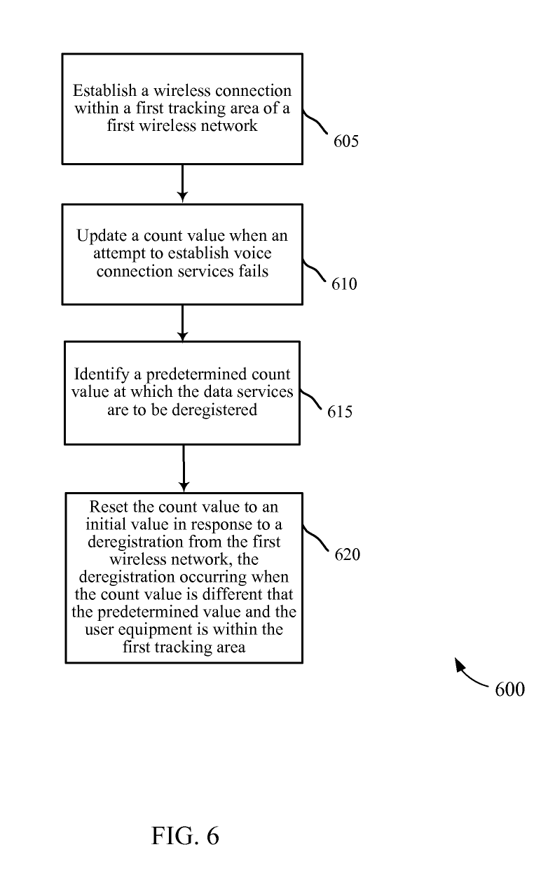

FIG. 6 illustrates a method 600 that may be carried out by a user equipment to establish data and voice communications services according to various embodiments. The method 600 may, for example, be performed by a user equipment of FIG. 1, 2, 3, 4 or 5, or using any combination of the devices described for these figures. Initially, at block 605, a wireless connection is established within a first tracking area of a first wireless network. The first wireless network may provide, for example, E-UTRAN services to user equipment having E-UTRAN connectivity capability. At block 610, a count value is updated when establishment of voice connection services fails. For example, a user equipment may receive a notice that a combined attach request is successful only for data services, indicating that the attempt to register voice connection services has failed. A counter at the user equipment may be set to an initial value of zero, and incremented in such a situation. In some embodiments, a counter may initially be set to a maximum number of voice services registration attempts, with the counter decremented from the initial value.

As indicated at block 615, a predetermined count value is identified at which data services are to be deregistered. In some embodiments, the predetermined count value may be set to a maximum number of attempts to establish voice connection services that are allowed for the user equipment before the user equipment is to deregister with the first wireless network and attempt to establish a connection with a different wireless network. Similarly, in embodiments where the initial count value is set at a maximum number of attempts and the count value is decremented upon a failed attempt to register voice connection services, the predetermined count value may be zero. At block 620, the count value is reset to an initial value in response to a deregistration from the first wireless network, the deregistration occurring when the count value is different than the predetermined value and the user equipment is within the first tracking area. As mentioned above, the initial count value may be zero, or a maximum number of voice connection services establishment attempts, for example.

When deregistration with the first wireless network occurs when the count is different than the predetermined value, this may indicate that deregistration from the first wireless network may have occurred for reasons unrelated to the failed voice services connection attempts. Thus, resetting the count value to an initial value allows user equipment in such a situation to use the full number of voice services connection attempts when a wireless connection to the first wireless network is attempted. As discussed above, the first wireless network may provide E-UTRAN data and voice connection services, for example, and resetting the count value as described may allow a user equipment the full number of combined attach requests, or combined TAU requests, before disabling E-UTRAN at the user equipment. Deregistration from the first wireless network may occur for any of a number of reasons, such as through a user requested deregistration, a network initiated deregistration, and/or the user equipment leaving the first tracking area, for example.

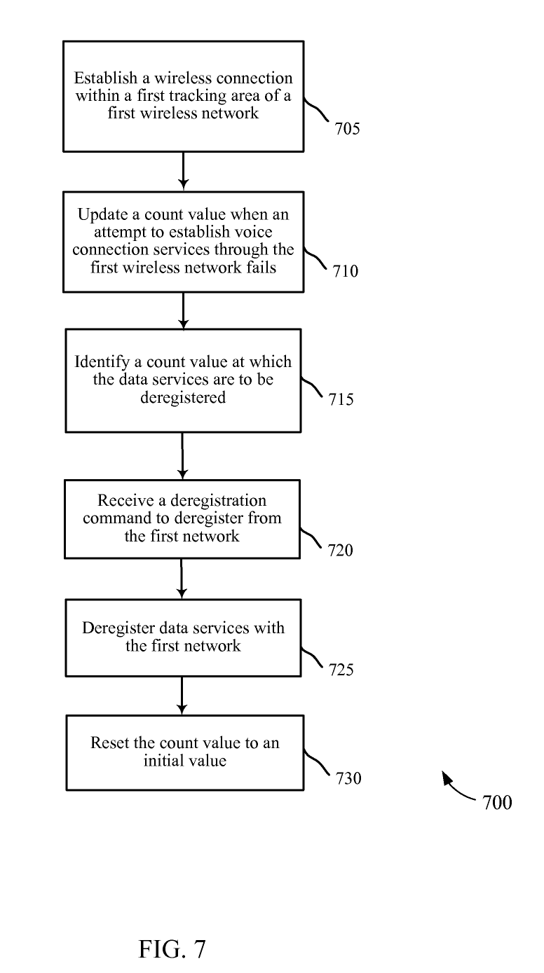

FIG. 7 illustrates another method 700 that may be carried out by a user equipment to establish data and voice communications services according to various embodiments. The method 700 may, for example, be performed by a user equipment of FIG. 1, 2, 3, 4 or 5, or using any combination of the devices described for these figures. Initially, at block 705, a wireless connection is established within a first tracking area of a first wireless network. The first wireless network may provide, for example, E-UTRAN services to user equipment having E-UTRAN connectivity capability. At block 710, a count value is updated when an attempt to establish voice connection services through the first wireless network fails. A count value is identified at which data services are to be deregistered, according to block 715. A deregistration command is received from the first network, at block 720. Such a command may be sent by the network for a variety of reasons, which may or may not be related to any failed attempts to register voice connection services. At block 725, data services are deregistered with the first wireless network. At block 730, the count value is reset to an initial value. Similarly as discussed above, the first wireless network may provide E-UTRAN data and voice connection services, for example, and resetting the count value as described may allow a user equipment the full number of combined attach requests, or combined TAU requests, before disabling E-UTRAN at the user equipment. Deregistration from the first wireless network may occur for any of a number of reasons, such as through a user requested deregistration, a network initiated deregistration, and/or the user equipment leaving the first tracking area, for example.

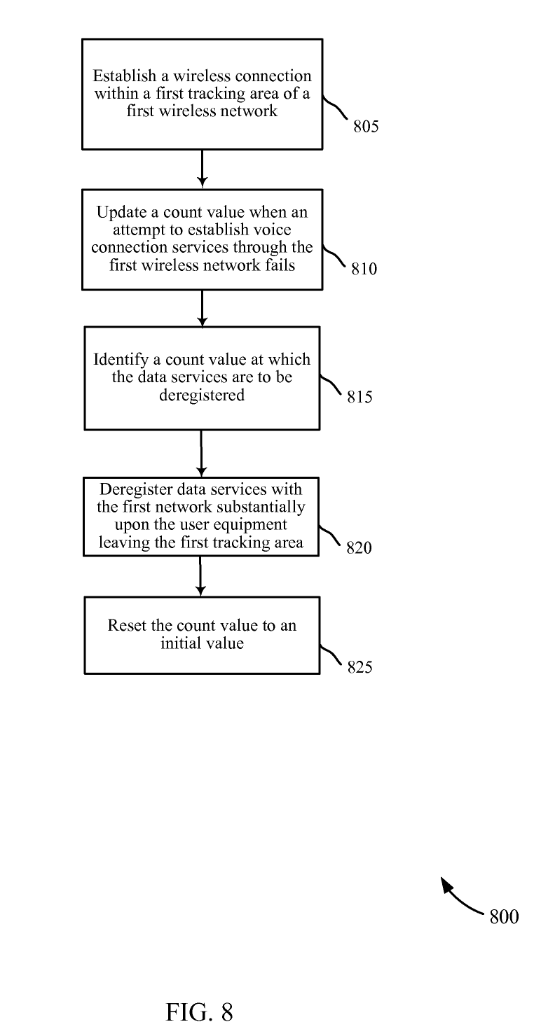

FIG. 8 illustrates another method 800 that may be carried out by a user equipment to establish data and voice communications services according to various embodiments. The method 800 may, for example, be performed by a user equipment of FIG. 1, 2, 3, 4 or 5, or using any combination of the devices described for these figures. Initially, at block 805, a wireless connection is established within a first tracking area of a first wireless network. The first wireless network may provide, for example, E-UTRAN services to user equipment having E-UTRAN connectivity capability. At block 810, a count value is updated when an attempt to establish voice connection services through the first wireless network fails. A count value is identified at which data services are to be deregistered, according to block 815. Data services are deregistered with the first network substantially upon the user equipment leaving the first tracking area, as indicated at block 820. At block 825, the count value is reset to an initial value. In such a manner, the user equipment may have the full number of attempts for registration of voice connection services upon re-entry into the first tracking area of the first wireless network. A user equipment may re-enter the first tracking area, for example, when a user of the user equipment takes the same route out of and back into the first tracking area, such as during a commute to and from a place of business.

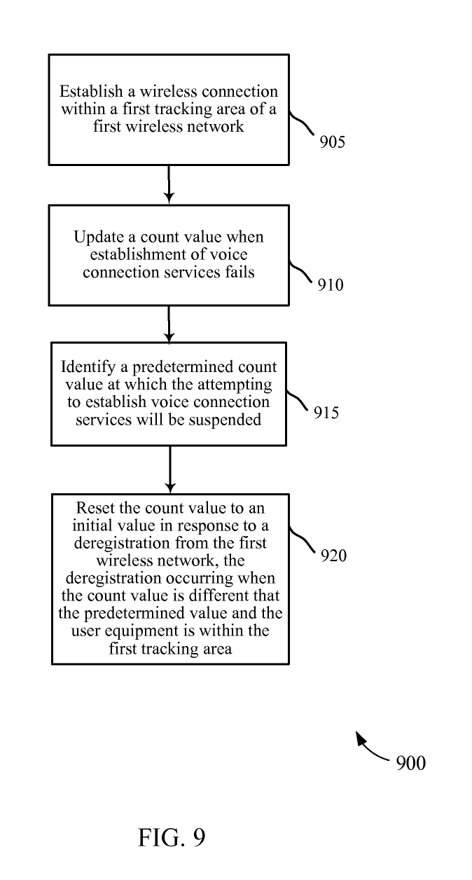

FIG. 9 illustrates another method 900 that may be carried out by a user equipment to establish data and voice communications services according to various embodiments. The method 900 may, for example, be performed by a user equipment of FIG. 1, 2, 3, 4 or 5, or using any combination of the devices described for these figures. Initially, at block 905, a wireless connection is established within a first tracking area of a first wireless network. The first wireless network may provide, for example, E-UTRAN services to user equipment having E-UTRAN connectivity capability. At block 910, a count value is updated when an attempt to establish voice connection services through the first wireless network fails. A predetermined count value is identified, at which the attempting to establish voice connection services will be suspended, according to block 915. In some embodiments, suspension of attempts to establish voice connection services includes deregistering data services with the wireless network (e.g., transitioning to a deregistered state in E-UTRAN) and attempting to register voice and data services on another wireless communications network (e.g., initiating a UTRAN or GERAN connection). In other embodiments, suspension of attempts to establish voice connection services includes discontinuing attempts to establish voice connection services while maintaining data services registration with the wireless communications network. In some embodiments, the user equipment may provide a notification to a user that voice services are not currently available and optionally provide for user input regarding deregistering data services with the wireless network in favor of attempting to establish voice and data services on a different network. At block 920, the count value is reset to an initial value in response to a deregistration from the first wireless network, the deregistration occurring when the count value is different than the predetermined value and the user equipment is within the first tracking area.

When deregistration with the first wireless network occurs when the count is different than the predetermined value, this may indicate that deregistration from the first wireless network may have occurred for reasons unrelated to the failed voice services connection attempts. Thus, resetting the count value to an initial value allows user equipment in such a situation to use the full number of voice services connection attempts when a wireless connection to the first wireless network is attempted. Similarly as discussed above, the first wireless network may provide E-UTRAN data and voice connection services, for example, and resetting the count value as described may allow a user equipment the full number of combined attach requests, or combined TAU requests, before disabling E-UTRAN at the user equipment. Deregistration from the first wireless network may occur for any of a number of reasons, such as through a user requested deregistration, a network initiated deregistration, and/or the user equipment leaving the first tracking area, for example.

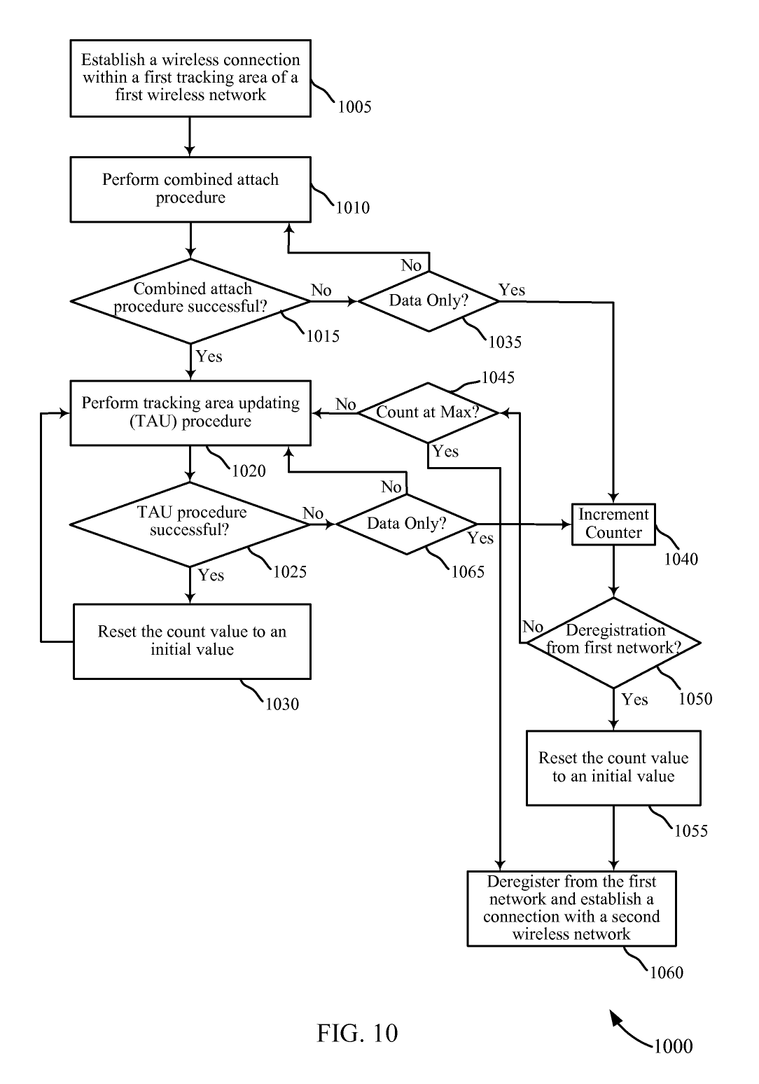

FIG. 10 illustrates another method 1000 that may be carried out by a user equipment to establish data and voice communications services according to various embodiments. The method 1000 may, for example, be performed by a user equipment of FIG. 1, 2, 3, 4 or 5, or using any combination of the devices described for these figures. Initially, at block 1005, a wireless connection is established within a first tracking area of a first wireless network. At block 1010, a combined attach procedure is performed. At block 1015, it is determined whether the combined attach procedure was successful. If the combined attach procedure was successful, a tracking update (TAU) procedure is performed, at block 1020. Such a TAU procedure may be periodically performed while a user equipment operates in the first wireless network. At block 1025, it is determined if the TAU procedure was successful. If the TAU procedure was successful, a count value is set to an initial value, as noted at block 1030.

If, at block 1015, it is determined that the combined attach procedure was not successful, it is determined, at block 1035, whether the combined attach procedure was successful for data services only. If the combined attach procedure was not successful for data, the operations at block 1010 are performed. If the combined attach was successful for data only, and not voice connection services, a counter is incremented according to block 1040. At block 1045, it is determined if the user equipment has been deregistered from the first network. If the user equipment has not been deregistered from the first network, it is determined at block 1050 whether the counter is at a maximum allowed number, corresponding to the maximum number of attempts to register for voice connection services are allowed. If the count is not at the maximum, operations of block 1020 are performed. If, at block 1045, it is determined that the user equipment has been deregistered from the first network, the count value is reset to an initial value, as noted at block 1055. At block 1060, the user equipment is deregistered from the first network and a connection with a second wireless network is established. At block 1025, if it is determined that the TAU procedure was not successful, it is determined if the TAU procedure was successful for data only, as noted at block 1065. If the TAU procedure was successful for data only, and not voice, the operations of block 1040 are repeated. If, at block 1050, it is determined that the count is at the maximum number, the operations of block 1060 are performed.

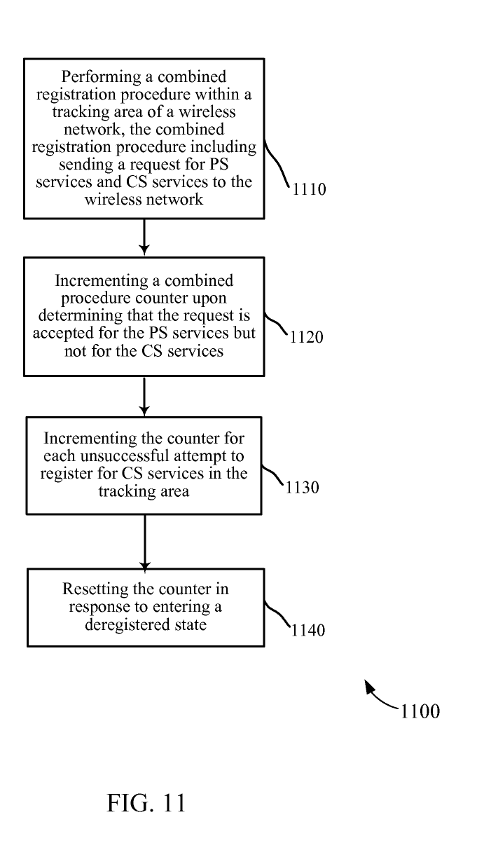

FIG. 11 illustrates a method 1100 that may be carried out by a user equipment to establish data and voice communications services. The method 1100, as well as methods 1200 and 1300 described below, may be performed by a user equipment of FIG. 1, 2, 3, 4 or 5, or using any combination of the devices described for these figures. The method 1100 may involve, at block 1110, performing a combined registration procedure within a tracking area of a wireless network, the combined registration procedure including sending a request for PS services and CS services to the wireless network. The method 1100 may involve, at block 1120, incrementing a combined procedure counter upon determining that the request is accepted for the PS services but not for the CS services. The method 1100 may involve, at block 1130, incrementing the counter for each unsuccessful attempt to register for CS services in the tracking area. The method 1100 may involve, at block 1140, resetting the counter in response to entering a deregistered state.

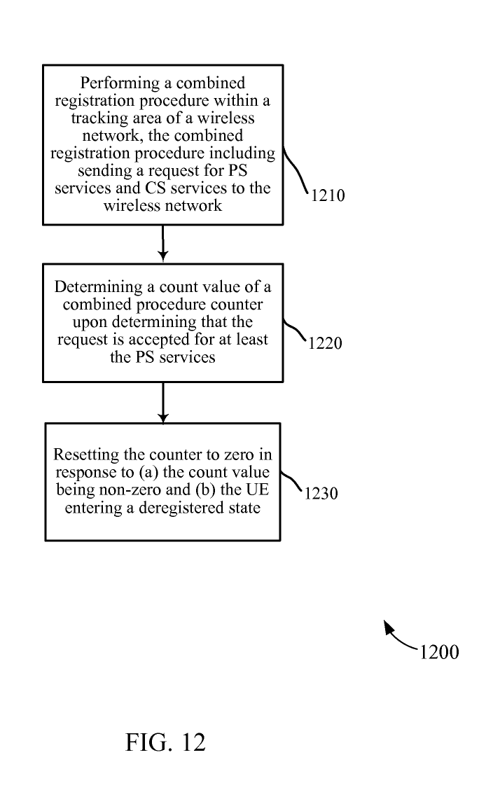

FIG. 12 illustrates another method 1200 that may be carried out by a user equipment to establish data and voice communications services. The method 1200 may involve, at block 1210, performing a combined registration procedure within a tracking area of a wireless network, the combined registration procedure including sending a request for PS services and CS services to the wireless network. The method 1200 may involve, at 1220, determining a count value of a combined procedure counter upon determining that the request is accepted for at least the PS services. The method 1200 may involve, at 1230, resetting the counter to zero in response to (a) the count value being non-zero and (b) the UE entering a deregistered state.

In related aspects, the method 1200 may further involve incrementing the counter upon determining that the request is accepted for the PS services but not for the CS services. In further related aspects, the method 1200 may involve: incrementing the counter for each unsuccessful attempt to register for CS services in the tracking area; and resetting the counter in response to entering the deregistered state. In yet further related aspects, the counter comprises a TAU counter or the like.

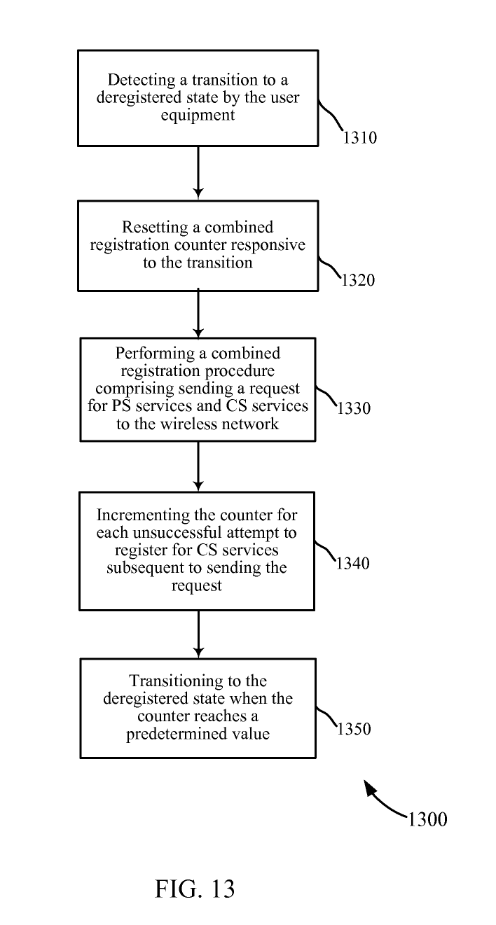

FIG. 13 illustrates another method 1300 that may be carried out by a user equipment to establish data and voice communications services. The method 1300 may involve, at block 1310, detecting a transition to a deregistered state by the user equipment. The method 1300 may involve, at block 1320, resetting a combined registration counter responsive to the transition. The method 1300 may involve, at block 1330, performing a combined registration procedure comprising sending a request for PS services and CS services to the wireless network. The method 1300 may involve, at block 1340, incrementing the counter for each unsuccessful attempt to register for CS services subsequent to sending the request. The method 1300 may involve, at block 1350, transitioning to the deregistered state when the counter reaches a predetermined value.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Techniques described herein may be used for various wireless communications systems such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The above description describes an LTE system for purposes of example, and LTE terminology is used in much of the description, although the techniques are applicable beyond LTE applications.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL are included in the definition of medium. Disk and disc, as used herein, include compact disc (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A method for wireless communication using a wireless user equipment (UE), comprising:
performing a combined registration procedure within a tracking area of a wireless network, the combined registration procedure including sending a request for packet switched (PS) services and circuit switched (CS) services to the wireless network;
incrementing a combined procedure counter upon determining that the request is accepted for the PS services but not for the CS services;
incrementing the counter for each unsuccessful attempt to register for CS services in the tracking area; and
resetting the counter in response to entering a deregistered state.

2. The method of claim 1, wherein the combined registration procedure comprises a combined attach procedure.

3. The method of claim 1, wherein the combined registration procedure comprises a combined tracking area update (TAU) procedure.

4. The method of claim 1, wherein the determining comprises receiving an accept message from the network indicating acceptance for the PS services but not for the CS services.

5. The method of claim 1, wherein entering the deregistered state comprises:
receiving a deregistration command from a user of the UE; and
deregistering the PS services with the wireless network.

6. The method of claim 1, wherein entering the deregistered state comprises:
receiving a command from the network to detach from the network;
deregistering the PS services with the network in response to receiving the command; and
resetting the counter to an initial value upon deregistering the PS services.

7. The method of claim 1, wherein entering the deregistered state comprises:
deregistering the PS services with the wireless network when the counter reaches a predetermined value; and
establishing a wireless connection with another wireless network.

8. The method of claim 1, further comprising:
receiving a notice that registration for the CS services in the network has failed; and
changing the counter from a first value to a second value.

9. The method of claim 8, further comprising, when the second value equals a predetermined value:
deregistering from the network; and
establishing a wireless connection with another wireless network.

10. The method of claim 8, further comprising:
receiving a command to deregister with the network, when the second value is different than a predetermined value; and
resetting the counter to an initial value upon deregistering the PS services.

11. An apparatus, comprising:
means for performing a combined registration procedure within a tracking area of a wireless network, the combined registration procedure including sending a request for packet switched (PS) services and circuit switched (CS) services to the wireless network;
means for incrementing a combined procedure counter upon determining that the request is accepted for the PS services but not for the CS services;
means for incrementing the counter for each unsuccessful attempt to register for CS services in the tracking area; and
means for resetting the counter in response to entering a deregistered state.

12. The apparatus of claim 11, wherein the combined registration procedure comprises a combined attach procedure.

13. The apparatus of claim 11, wherein the combined registration procedure comprises a combined tracking area update (TAU) procedure.

14. The apparatus of claim 11, further comprising means for receiving an accept message from the network indicating acceptance for the PS services but not for the CS services.

15. The apparatus of claim 11, further comprising:
means for receiving a deregistration command from a user of the UE; and
means for deregistering the PS services with the network.

16. The apparatus of claim 11, further comprising:
means for receiving a command from the network to detach from the network;
means for deregistering the PS services with the network in response to receiving the command; and
means for resetting the counter to an initial value upon deregistering the PS services.

17. The apparatus of claim 11, further comprising:
means for deregistering the PS services with the network when the counter reaches a predetermined value; and
means for establishing a wireless connection with another wireless network.

18. A wireless communications device, comprising:
a radio frequency (RF) transceiver;
at least one processor coupled to the RF transceiver and configured to:
perform a combined registration procedure within a tracking area of a wireless network, the combined registration procedure including sending a request for packet switched (PS) services and circuit switched (CS) services to the wireless network;
increment a combined procedure counter upon determining that the request is accepted for the PS services but not for the CS services;
increment the counter for each unsuccessful attempt to register for CS services in the tracking area; and
reset the counter in response to entering a deregistered state; and
at least one memory coupled with the at least one processor.

19. The device of claim 18, wherein the combined registration procedure comprises a combined attach procedure.

20. The device of claim 18, wherein the combined registration procedure comprises a combined tracking area update (TAU) procedure.

21. The device of claim 18, wherein the at least one processor determines whether the request is accepted for the PS services but not for the CS services by receiving an accept message from the network indicating acceptance for the PS services but not for the CS services.

22. A computer program product, comprising:
a non-transitory computer-readable medium, comprising:
code for performing a combined registration procedure within a tracking area of a wireless network, the combined registration procedure including sending a request for packet switched (PS) services and circuit switched (CS) services to the wireless network;
code for incrementing a combined procedure counter upon determining that the request is accepted for the PS services but not for the CS services;
code for incrementing the counter for each unsuccessful attempt to register for CS services in the tracking area; and
code for resetting the counter in response to entering a deregistered state.

23. The computer program product of claim 22, wherein the combined registration procedure comprises a combined attach procedure.

24. The computer program product of claim 22, wherein the combined registration procedure comprises a combined tracking area update (TAU) procedure.
